(19) United States
(12) Patent Application Publication
(10) Pub. No.: US 2014/0247924 A1
(43) Pub. Date: Sep. 4, 2014

(54) RADIATION SHIELD TO LOCALLY IRRADIATE RADIATION

(71) Applicant: Research & Business Foundation Sungkyunkwan University, Suwon-si (KR)

(72) Inventors: Suk Chan LEE, Suwon-si (KR); Jae Won SHIN, Seoul (KR); Seung-Woo HONG, Gwacheon-si (KR); Kangsan ROH, Seoul (KR); So Yoon PARK, Osan-si (KR); Jae Hyun PARK, Suwon-si (KR)

(73) Assignee: Research & Business Foundation Sungkyunkwan University, Suwon-si (KR)

(21) Appl. No.: 14/101,574

(22) Filed: Dec. 10, 2013

(30) Foreign Application Priority Data
Dec. 11, 2012 (KR) 10-2012-0143914
Dec. 10, 2013 (KR) 10-2013-0153219

(51) Int. Cl. G21F 1/08; G21K 1/00

(52) U.S. Cl. CPC G21F 1/08; G21K 1/00
USPC 378/204

(57) ABSTRACT

A radiation shield to locally apply radiation includes a source irradiating the radiation, and a shielding member is formed so that the radiation is incident only to a localized area of an object or a body to be inspected or treated and the other parts are shielded. According to the present invention, since the radiation is applied only to a part to be radiographed or treated, it is possible to provide the radiation shield which may locally irradiate the radiation to an object or a body to be inspected or treated. Furthermore, according to the present invention, it is possible to provide the radiation shield which may be used along with a radiation irradiation apparatus (⁶⁰Co Therapy, CyberKnife: a collimated source) universally used in existing medical institutions and also may accommodate a separate radioactive source (an uncollimated source) to be used.

### CROSS-REFERENCE TO RELATED APPLICATION

This application claims priority to and the benefit of Korean Patent Application No. 10-2012-0143914, filed on Dec. 11, 2012, and Korean Patent Application No. 10-2013-0153219, filed on Dec. 10, 2013, the disclosure of which is incorporated herein by reference in its entirety.

### BACKGROUND

1. Field of the Invention

The present invention relates to a radiation shield for irradiation to affect only a localized area.

2. Discussion of Related Art

X-rays or gamma rays which are radiations often used for radiation photographing or therapy have high energies, and thus has a considerable radiation effect on a substance.

Furthermore, the X-rays or gamma rays have different transmittance for different materials according to the density and the atomic number of the substance being irradiated, and thus are widely used for radiation inspection or medical treatment.

When developing food products, medicines, and the like in universities or in research laboratories, experiments are carried out often by using laboratory animals such as mice and rats, and radiography or radiotherapy using the X-rays and the like are performed for purposes related to medical treatment or life science research.

However, in most conventional experiments using radiation for laboratory animals, X-rays or gamma rays are irradiated to a whole body of the laboratory animal as described in Korean Patent Publication No. 2011-0058496.

Therefore, even when it is desired to irradiate only a part of the laboratory animal, the radiation is undesirably irradiated to the whole body of the laboratory animal and thus causes an unnecessary influence on the animal under observation or treatment. As a result, it may not be possible to obtain correct experimental or therapeutic results due to the unnecessary dose to other parts of the animal body.

Also, when the radiation is locally irradiated to a cancer patient to remove a tumor, side effects in cancer treatments are generated by the unnecessary radiation applied to normal tissues enclosing the tumor. In spite of an increasing demand for radiation therapy, a conventional radiotherapy system may not always be effective in relieving the pains of the cancer patients and their family or guardians due to limitations of technology thereof.

### SUMMARY OF THE INVENTION

The present invention is aimed for a radiation shield to locally irradiate radiation so that the radiation may be localized only in a target area.

The present invention is also aimed for a radiation shield to locally irradiate radiation so that other parts of an object or a body to be treated or inspected may be maximally shielded from the radiation.

According to the nature of the present invention, the invention provides a radiation shield for irradiation in a localized area by designing the shielding members so that the radiation from a source affects only a localized area of an object or a body (of an animal or a human) to be inspected or treated and the other parts are sufficiently well shielded and thus unaffected.

The present invention is also directed to a radiation shield to locally irradiate radiation, which may be used along with an irradiation apparatus (⁶⁰Co Therapy, CyberKnife: a collimated source) universally used in existing medical institutions or may also be used with a separate radioactive source (an uncollimated source).

When X-ray or gamma-ray beams are incident perpendicular to the shield and water phantom as illustrated in FIG. 1, the relative absorbed dose in the water phantom can be calculated by Equation 1 as follows:

$$100 \times \frac{{[ exp ( - μρ t ) ]}^{a}}{1 + {bt}^{2} + ct} \times [ \frac{1}{1 + {dt}^{3} + {et}^{2} + ft} ] \qquad [ Equation 1 ]$$

wherein μ is the attenuation coefficient [cm²/g], ρ is the density [g/cm³] of the shielding member, t is the thickness [cm] of the shielding member, and Z is the atomic number of the shielding member, (a=a₁×ρ^{a}^{₂}×Z^{a}^{₃}, b=b₁×ρ^{b}^{₂}×Z^{b}^{₃}, c=c₁×ρ^{c}^{₂}×Z^{c}^{₃}), where the detailed values of the constants are described in the exemplary embodiment.

The shielding member may be formed of one or more of tungsten (W), lead (Pb), copper (Cu), stainless steel (SS), and aluminum (Al) according to the relative absorbed dose of each material as given by Equation 1, which has information on the materials. Any other materials can be used for the shielding member as well, because μ, ρ and Z can be given for most materials.

When a collimated source (10a) in FIG. 3 is used, the shielding member may be decided by considering the shielding rate, which is defined by the following ratio:

$$Shielding rate = 100 - 100 \times ( \frac{maximum absored dose in voxel j ( L 1 , L 2 , L 3 , L 4 , L 5 )}{maximum absored dose in voxel i ( L 1 , L 2 , L 3 , L 4 , L 5 )} )$$

where i(L1,L2,L3,L4,L5) and j(L1,L2,L3,L4,L5) are the voxels shown in FIG. 4.

The shielding rate of the shielding member is decided by Equation 2A (for ⁶⁰Co therapy) or Equation 2B (for CyberKnife) as follows:

$$\begin{matrix}100 - 100 [ {\{ exp ( - μ ρ t ) \}}^{a} + \{ b + \frac{c}{d} \} \times \{ {exp ( - μ ρ t \}}^{e} ] / [ 1 + b + c ] \\ ( a = {a}_{1} \times {ρ}^{{a}_{2}} , b = 1 / ( {b}_{1} \times {ρ}^{{b}_{2}} ) , d = 1 + {d}_{1} {ρ}^{{d}_{2}} {Z}^{{d}_{s}} t ) . & [ Equation 2 A ] \\ 100 - 100 [ {\{ exp ( - μ ρ t ) \}}^{a} + \{ b + c \times \frac{d}{e} \} \times \{ {exp ( - μ ρ t \}}^{f} ] / [ 1 + b + c ] \\ ( a = {a}_{1} \times {ρ}^{{a}_{2}} , b = {b}_{1} + {b}_{2} \times {Z}^{{b}_{2}} , c = {c}_{1} \times {ρ}^{{c}_{1}} \times {Z}^{{c}_{3}} , d = {\{ exp ( - \frac{1}{{d}_{1} {ρ}^{{d}_{2}}} t ) \}}^{{d}_{3} {ρ}^{d}} , e = 1 + {e}_{1} t ) , & [ Equation 2 B ]\end{matrix}$$

where the definition of parameters are given in the embodiment, and the first shielding member (200) in FIG. 3. can be decided by using Equation 2A or 2B.

The shielding member may have a through-hole through which the radiation passes.

The radiation source may be a collimated source (10a) as in FIG. 3 or an uncollimated source (10b) as in FIG. 8, and the shielding member may be decided by the corresponding relative absorbed doses, which are described herewith.

When an uncollimated source (10b) is used, the first shielding member (200) of the shielding members may be made of one of tungsten, lead, copper, stainless steel, and aluminum by using Equation 2A or 2B, and the radiation shield may further include a second shielding member made of any one of tungsten, lead, copper, stainless steel, and aluminum.

The shielding rate of the second shielding member (300a) when it is used together with the first shielding member (200) may be decided by Equation 3 as follows:

$$100 - 100 [ exp ( - at ) + \{ b + \frac{1}{1 + ct} \} \times exp ( - dt ) ] \text{/} [ 2 + b ] \qquad [ Equation 3 ]$$

wherein a, b, c, and d are the constants that are defined in the embodiment.

The thickness t of the first shielding member (200) may be decided by Equation 2A or 2B.

The thickness t of the second shielding member (300a) may be decided by Equation 3.

The radiation shield may further include a fixing frame (650) having a hole (669) and a memory member (680) in the internal space of the fixing frame (650).

The memory member (680) may include a polyurethane material which can be easily deformed and remains so according to the shape of the object or body to be inspected or treated.

### BRIEF DESCRIPTION OF THE DRAWINGS

The unique features and advantages of the present invention will become clear through the description of detailed exemplary embodiments thereof with reference to the accompanying drawings, in which:

FIG. 1 is a schematic side view showing a situation where the water phantom represents an object or a body to be irradiated and the shield is to prevent the radiation from affecting the object or body according to the present invention;

FIGS. 2A and 2B are the graphs showing the shielding rate of a shielding body according to the material and thickness thereof, when a beam is incident perpendicular to the shielding body;

FIG. 3 is a schematic side view testing the shielding rate when a collimated source is used;

FIG. 4 is a schematic side view illustrating the situation where the water phantom is divided into small voxels in order to estimate a relative radiation dose deposited to the water phantom;

FIGS. 5A and 5B are the graphs showing the shielding rate of the shielding body according to the material and the thickness thereof, when a collimated source (10a) (⁶⁰Co Therapy) is used;

FIGS. 6A and 6B are the graphs showing the shielding rate of the shielding body according to the material and the thickness thereof, when a collimated source (10a) (CyberKnife) is used;

FIG. 7 is a graph showing the relative dose deposited to the water phantom against the depth in the water phantom in FIG. 4 when the tungsten shield (200) is 6 cm long;

FIG. 8 is a schematic side view to estimate the thickness of the shielding body when an uncollimated source is used;

FIG. 9 is a graph showing the shielding rate as a function of the thickness of shielding members (200, 300a) in FIG. 8;

FIG. 10 is a schematic side view illustrating the situation in which a radiation guide part (400) is placed in the second shielding member in FIG. 8;

FIG. 11 is a graph showing the shielding rate as a function of the thickness of the shielding body when the first shielding member is made of tungsten (6 cm) and the second shielding member is made of stainless steel, and when both the first and second shielding members are made of stainless steel;

FIG. 12 is a graph showing the shielding rate when the lead (Pb) radiation guide (400) is added as shown in FIG. 10;

FIG. 13 is a graph showing the relative dose as a function of the depth in the water phantom for different values of the thickness of the shielding member when an uncollimated source is used;

FIG. 14 is a schematic side view illustrating a exemplary case in which an uncollimated source is used and the second shielding member is made of stainless steel;

FIG. 15 is a schematic side view illustrating an exemplary case in which the uncollimated source is used and the second shielding member is made of aluminum;

FIG. 16 is a graph showing the distribution of relative dose deposited to the water phantom as a function of the transverse distance (in the X-axis as shown in FIG. 3.) in FIGS. 3, 14, and 15; and

FIG. 17 is a schematic side view of a fixing part of an object or a body that can be used together with the radiation shield.

### DETAILED DESCRIPTION OF EXEMPLARY EMBODIMENTS

Various embodiments of the present invention will be described herein below with reference to the accompanying drawings. In the drawings, the same components are designated by the same reference numerals, even though they are depicted in different drawings. Furthermore, in the following description, detailed descriptions of well-known functions or constructions will be omitted because they might obscure a gist of the invention due to unnecessary details.

Exemplary embodiments of the present invention are to provide a radiation shield which may most effectively localize the irradiated region for different types of the radiation.

To this end, the radiation shield is modeled so that the radiation is irradiated only to a target area of an object to be inspected or treated, and the other area of the object is maximally shielded.

First of all, to achieve this characteristic, the thickness of a shielding member is decided according to the material of the shielding member.

The radiation source may be divided into a collimated source and an uncollimated source, and the shielding members are designed for each case to maximize the shielding efficiency.

The thickness of the shielding member is decided according to the material thereof as follows.

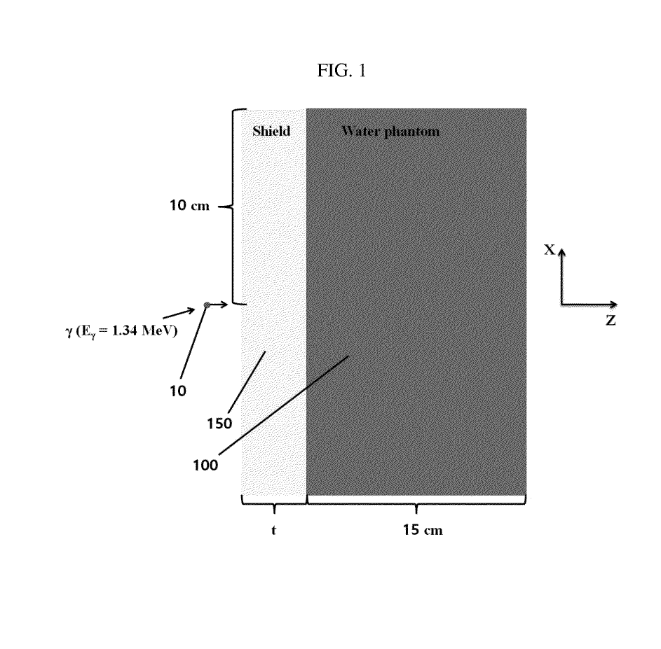

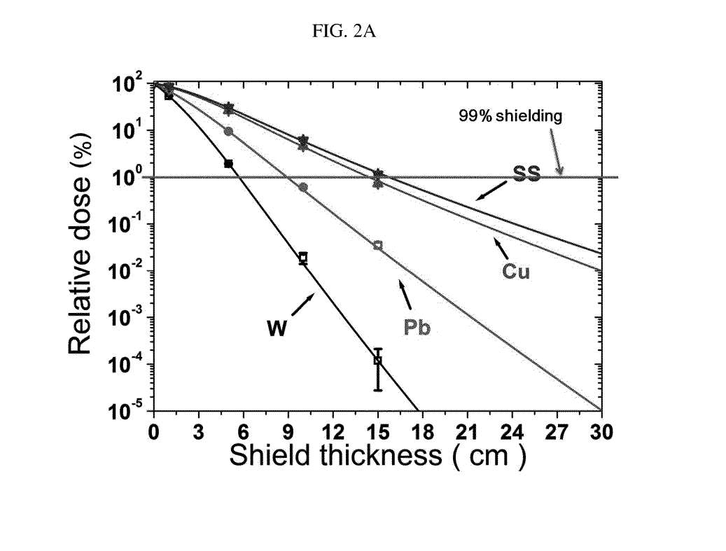

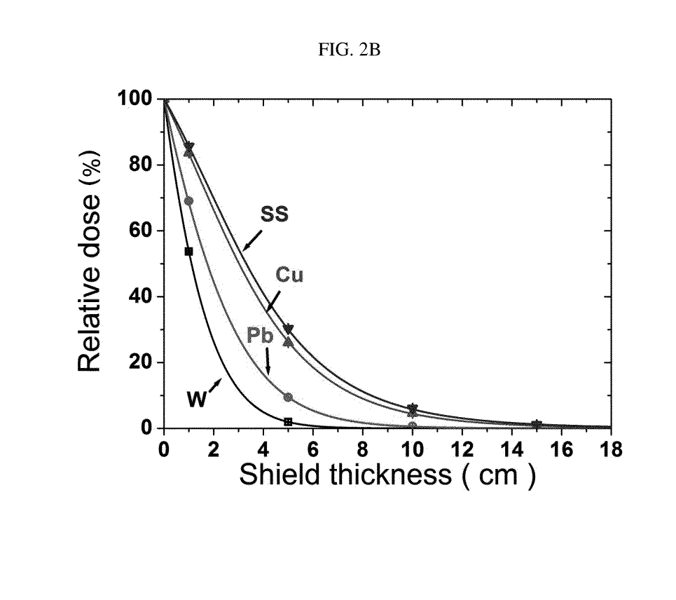

As illustrated in FIG. 1, in a situation in which a water phantom 100 has a thickness of 15 cm and a shielding body 150 which is in direct contact with the front side of the water phantom 100 has a thickness of t, if a gamma ray having energy of 1.34 MeV is irradiated from a radiation source 10, the relative dose deposited to the water phantom as shown in FIGS. 2A and 2B is produced.

In FIG. 1, a gamma ray source is positioned at a central front side of the shielding body 150 which has the shape of a cylinder of radius 10 cm.

The water phantom 100 is used as an object to be inspected or treated. Since the size of a small laboratory animal used in a clinical experiment generally has a length of 20 cm or less, the water phantom 100 is also formed to have the distance of 10 cm from the center to the edge, which makes the distance from one end to the other 20 cm.

FIGS. 2A and 2B show the relative absorbed dose in the water phantom 100 with the shield body 150 made of different materials. The relative dose is evaluated with respect to the value of dose when the shield thickness t is zero, which means the absence of the shielding body 150. The thickness thereof, when a beam is incident perpendicular to the shielding body in the Z-direction.

The relative absorbed dose as shown in FIGS. 2A and 2B may be decided by the following Equation 1:

$$100 \times \frac{{[ exp ( - μ ρ t ) ]}^{a}}{1 + {bt}^{2} + ct} \times [ \frac{1}{1 + {dt}^{3} + {et}^{2} + f t} ] \qquad [ Equation 1 ]$$

In Equation 1, μ is the attenuation coefficient [cm²/g], ρ is the density [g/cm³] of the shielding member, t is the thickness [cm] of the shielding member, and Z is the atomic number of the shielding member.

Here, since the attenuation coefficient, the density, and the atomic number correspond to properties of a substance, the relative absorbed dose according to the thickness of the shielding member may be calculated by Equation 1.

The parameters in Equation 1 are such that a,

(a=a₁×ρ^{a}^{₂}×Z^{a}^{₃},b=b₁×ρ^{b}^{₂}×Z^{b}^{₃},c=c₁×ρ^{c}^{₂}×Z^{c}^{₃}) where

a₁=0.099667, a₂=0.166995, a₃=0.325636, b₁=9.67096e-11, b₂=4.77263, b₃=1.17105, c₁=−5.09721e-10, c₂=4.03249, c₃=1.57042, d=0.000121578, e=0.0242004, and f=−0.0387995.

Therefore, through the relative absorbed dose calculated by Equation 1, it was found that tungsten (W) of 5.7 cm thickness, lead (Pb) of 9 cm thickness, copper (Cu) of 14 cm thickness, and stainless steel (SS) of 15.5 cm thickness were required in order to shield the radiation up to 99% as shown in FIG. 2A.

As shown in FIGS. 2A and 2B, when each substance has a certain thickness or more, the shielding rate thereof is saturated.

In the actual simulation, each substance was tested until the thickness reaches 30 cm. However, since the change in the relative dose against the thickness may be expressed by Equation 1, Equation 1 is valid for larger thickness even up to infinity. However, when a concrete dimension is needed, the maximum thickness may be chosen as 100 to 200 cm to be realistic.

Furthermore, even in the case of aluminum having a density which is smaller than the above-mentioned other shielding materials, the shielding rate can be described by Equation 1, because Equation 1 is a general expression valid for any solid materials where μ, ρ, and Z can be given.

Among the above-mentioned materials for the shielding body 150, tungsten (W) shows the best shielding efficiency, and lead (Pb), copper (Cu), and stainless steel (SS) follow in that order. Hereinafter, tungsten is used for the shielding member 200 to minimize the total length of the shield, but in general other materials of different thickness values can be used as well.

In the exemplary embodiment, the type of radiation is divided into the case of a collimated beam from a source with a collimator and the case of an uncollimated beam from a source without using a collimator. In each case, a structure for achieving the optimal local irradiation at low costs is provided.

In the first case with a collimated beam, the beam is shaped in the form of a parallel ray with a minor dispersion, and thus when the first shielding member 200 made of tungsten (W) has a thickness of 6 cm, the shielding rate is 99% or higher.

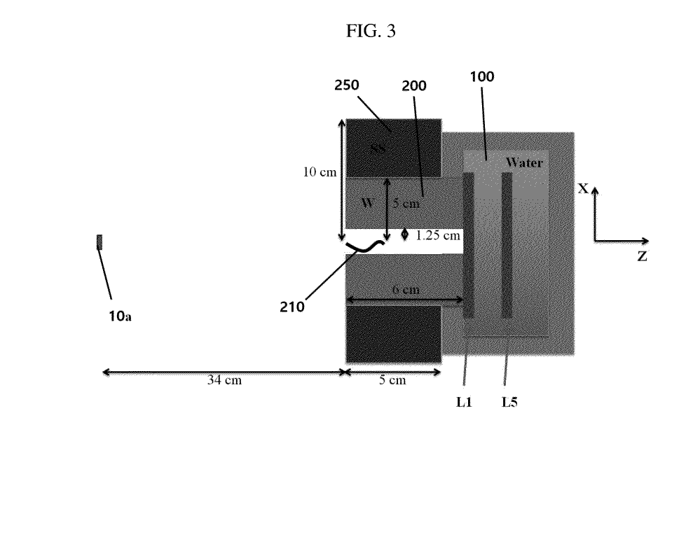

FIG. 3 is a schematic side view for testing the shielding rate when a collimated source 10a is used.

In the exemplary embodiment of the present invention, as illustrated in FIG. 3, the first shielding member 200 at the front side of the water phantom 100 has a thickness of 6 cm and the external diameter of 5 cm, and a through-hole 210 formed therein has a diameter of 1.25 cm.

The diameter of the through-hole 210 can be chosen as 1.25 cm or less because only a small area of the object to be inspected or treated needs to be locally irradiated. Generally, a range of a body for sentinel lymphangiography to check whether cancer has metastasized has a diameter less than 1.25 cm.

The first external shielding member 250 made of stainless steel (SS) is provided outside the first shielding member 200. The first external shielding member 250 made of stainless steel (SS) has an external diameter of 10 cm.

The first external shielding member 250 is provided to prevent the radiation incident to the surface of the first shielding member 200 from entering and causing a influence on the water phantom 100.

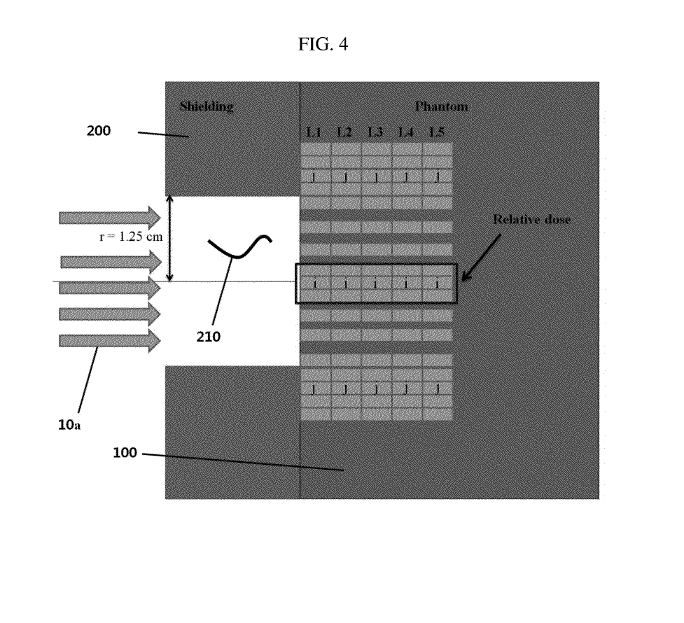

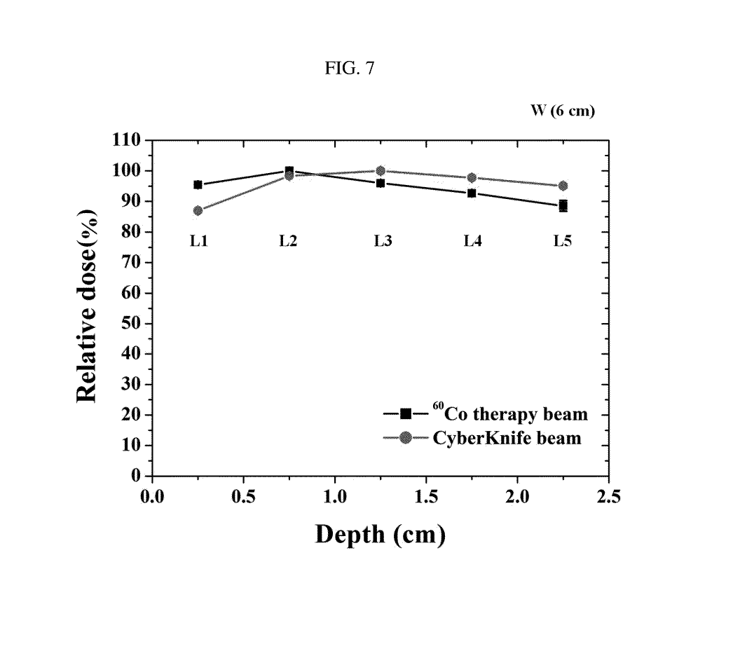

FIG. 4 is a schematic side view illustrating the situation where the water phantom 100 is divided into small voxels in order to estimate the relative absorption dose. The length and width of each voxel is 0.5 cm and 0.2 cm, respectively. In calculating the relative dose and the shielding rate, the reference voxel is chosen as one of those in the central region outlined by a black square in FIG. 4. The voxel in this square with the highest absorption dose is taken as a reference voxel. Then the voxels denoted by j(L1, . . . , L5) in FIG. 4 are considered to calculate the absorbed dose in each of them, j(L1), j(L2), . . . , and j(L5). That is, the maximum value of the absorbed dose in these voxels is divided by the maximum value of the reference voxel in the central region to produce the shielding rate. FIG. 7 is a graph showing the relative dose as a function of the depth in the water phantom 100 in FIG. 4 when the shield member 200 made of tungsten is 6 cm.

In FIG. 4, if the radiation is incident to the water phantom 100 through the through-hole 210 with the diameter of 1.25 cm, the relative dose as a function of the depth in the water phantom 100 may be estimated, as shown in FIG. 7. Regardless of whether the beam is a ⁶⁰Co therapy beam or a CyberKnife beam, it was found that a dose of 85% or higher was uniformly deposited in the region where the depth is 0˜2.5 cm.

The result as described above will be decided by the following equation.

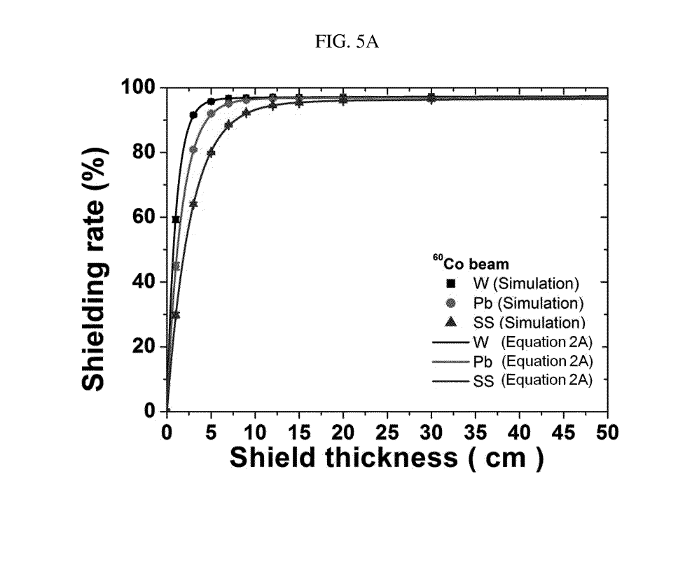

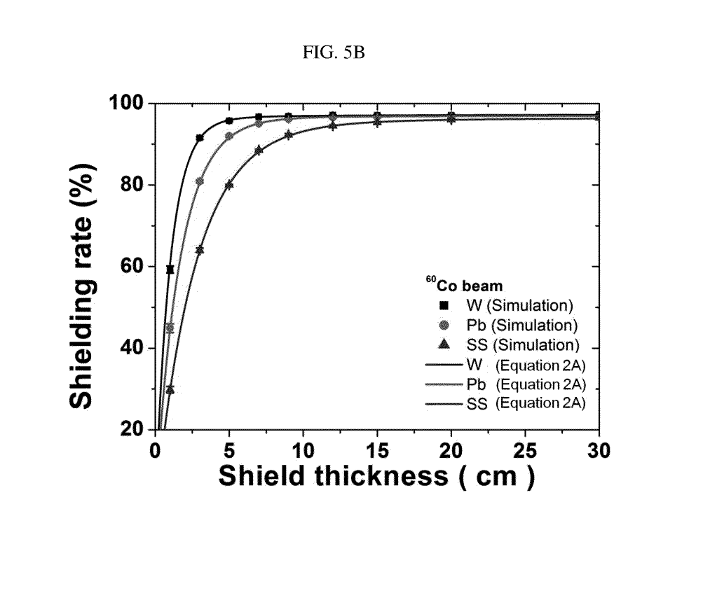

Firstly, as shown in FIGS. 5A and 5B, in the case of the ⁶⁰Co therapy beam the shielding rate due to the shielding member 200 is decided by Equation 2A.

$$100 - 100 [ {\{ exp ( - μ ρ t ) \}}^{a} + \{ b + \frac{c}{d} \} \times \{ {exp ( - μ ρ t \}}^{e} ] / [ 1 + b + c ] \qquad [ Equation 2 A ]$$

In Equation 2A, μ is the attenuation coefficient [cm²/g], ρ is the density [g/cm³] of the shielding member, t is the thickness [cm] of the shielding member, and Z is the atomic number of the shielding member.

Here, the parameters (a=a₁×ρ^{a}^{₂}, b=1/(b₁×ρ^{b}^{₂}), d=1+d₁ρ^{d}^{₂}Z^{d}^{₃}t) are such that a₁=0.765784, a₂=0.0574645, b₁=19.6264, b_{z}=0.175383, c=0.0738262, d₁=0.00222039, d₂=0.000188689, d₃=1.55438, and e=0.00107176.

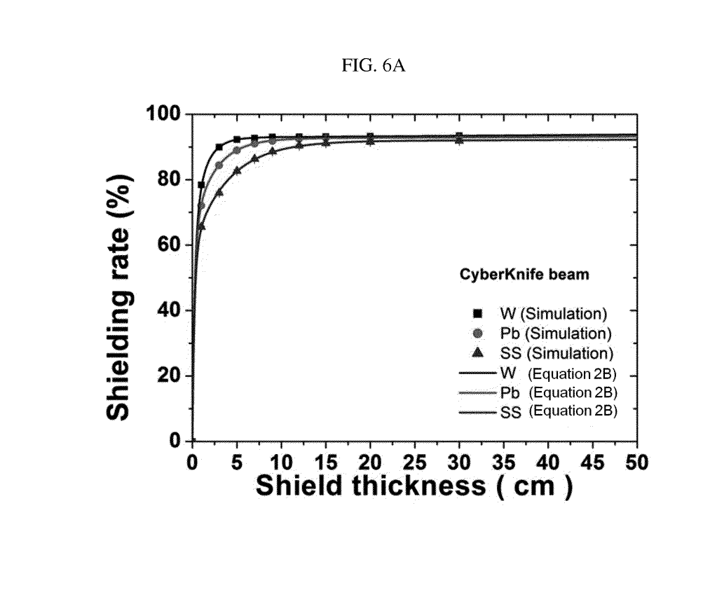

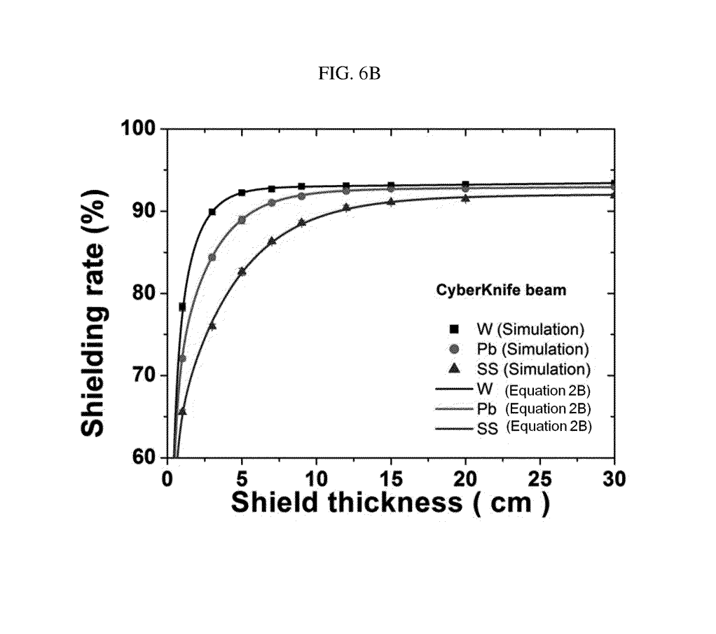

Then, as shown in FIGS. 6A and 6B, in the case of the CyberKnife beam, the shielding rate of the shielding member is decided by Equation 2B.

$$100 - 100 [ {\{ exp ( - μ ρ t ) \}}^{a} + \{ b + c \times \frac{d}{e} \} \times \{ {exp ( - μ ρ t \}}^{f} ] / [ 1 + b + c ] \qquad [ Equation 2 B ]$$

In Equation 2B, μ is the attenuation coefficient [cm²/g], μ is the density [g/cm³] of the shielding member, t is the thickness [cm] of the shielding member, and Z is the atomic number of the shielding member.

Here, the parameters

$$( a = {a}_{1} \times {ρ}^{{a}_{2}} , b = {b}_{1} + {b}_{2} \times {Z}^{{b}_{3}} , c = {c}_{1} \times {ρ}^{{c}_{2}} \times {Z}^{{c}_{3}} , d = {\{ exp ( - \frac{1}{{d}_{1} {ρ}^{{d}_{2}}} t ) \}}^{{d}_{3} {ρ}^{{d}_{1}}} , e = 1 + {e}_{1} t )$$

are such that a₁=0.425775, a₂=0.197555, b₁=0.0768937, b₂=0.142399, b₃=0.0716249, c₁=0.779875, c₂=0.129205, c₃=0.182294, d₁=0.11735, d₂=0.767605, d₃=0.45297, d₄=0.539619, e₁=2.49238, and f=0.003.

That is, the first shielding member is decided by the shielding rate calculated by Equation 2A or 2B. The result according to Equation 2A is illustrated in FIGS. 5A and 5B, and the result according to Equation 2B is illustrated in FIGS. 6A and 6B.

As illustrated in FIGS. 5A to 6B, when each substance has a certain thickness or more, the shielding rate thereof is saturated.

In the actual simulation, each substance was tested until the thickness became 30 cm. Since the change in the shielding rate against the thickness may be described by Equation 2A or 2B, the Equation 2A or 2B is valid for larger distances even up to infinity.

However, when a concrete dimension is needed, the maximum thickness may be chosen as 100 to 200 cm to be realistic.

In Equations 1, 2A, and 2B, a single substance was applied according to the attenuation coefficient, the density, and the atomic number thereof.

However, in the case of a mixture, the shielding rate of the mixture may be obtained by using an average atomic number of the mixture and an attenuation coefficient corresponding to the mixture.

In the exemplary embodiment of the present invention, when the collimated source 10a is used, the first shielding member 200 of 6 cm thickness with the through-hole 210 of the shielding member 200 of 1.25 cm diameter can produce a localized irradiation.

On the other hand, when an uncollimated source 10b is used, the shielding structure is as follows.

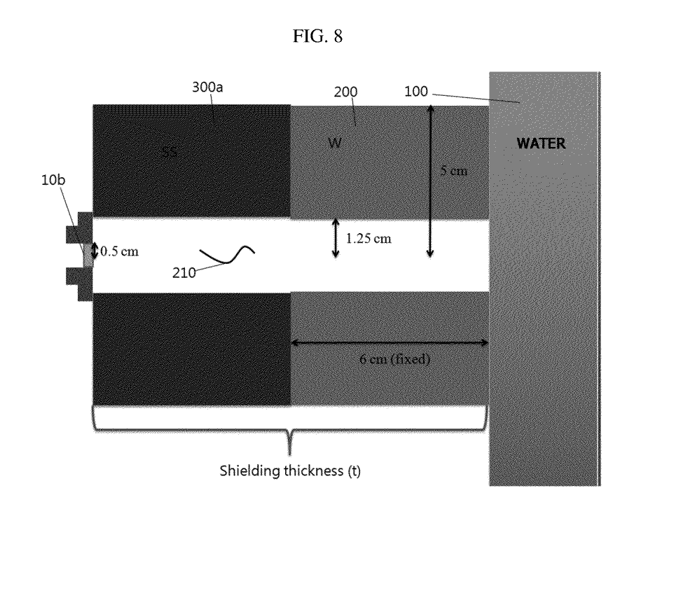

FIG. 8 is a schematic side view to estimate the thickness of the shielding body when an uncollimated source 10b is used.

In the case of using an uncollimated source 10b, the beam is dispersed to all directions, and thus the second shielding member 300a functioning as a collimator is placed at the front side of the first shielding member 200, as illustrated in FIG. 8.

The second shielding member 300a is placed on the front surface of the first shielding member 200 and is decided after the first shielding member 200 is predetermined.

In FIG. 8, the second shielding member 300a is made of stainless steel (SS).

The first shielding member 200 made of tungsten (W) has a thickness of 6 cm, and an internal through-hole 210 of the first and second shielding members 200 and 300a has a diameter of 1.25 cm.

The second shielding member 300a is made of stainless steel (SS) because stainless steel (SS) is cheaper than tungsten (W) and yet can be used to produce a sufficient shielding rate.

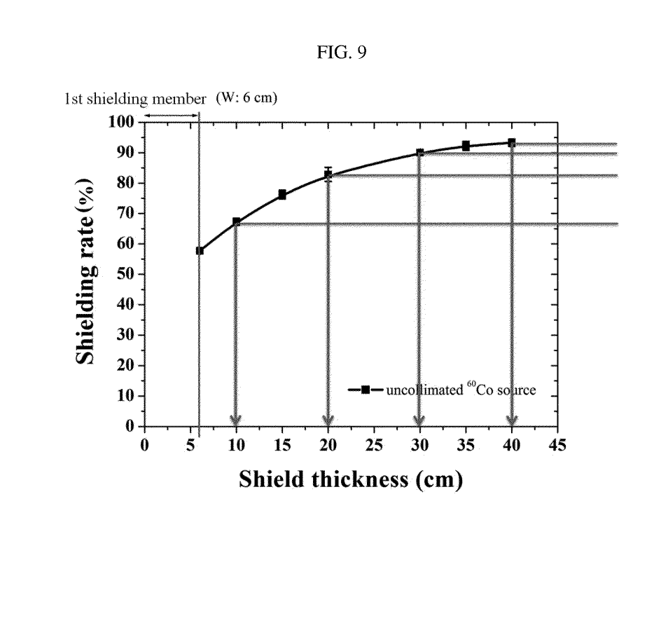

FIG. 9 is a graph showing the shielding rate against the thickness of the shielding member 300a when the shielding member 200 is used as in FIG. 8.

As can be seen in FIG. 9, the thickness where the shielding rate saturates when an uncollimated source 10b is used is approximately 40 cm or more. In this case the length of the first shielding member 200 is 6 cm, and the length of the second shielding member 300a made of stainless steel is 34 cm.

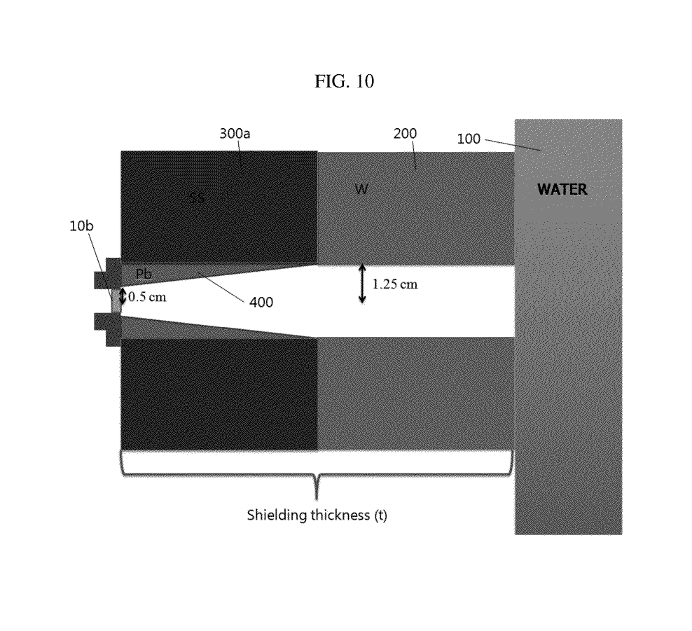

FIG. 10 is a schematic side view illustrating the situation in which an uncollimated source is used, where a lead radiation guide part 400 is included in the second shielding member 300a.

The first shielding member 200 may be decided by Equation 2A or 2B. When both the first and second shielding members are used together, the shielding rate can be decided by Equation 3. The material of the first shielding member can be tungsten or stainless steel. The material of the second shielding member is stainless steel.

$$100 - 100 [ exp ( - at ) + \{ b + \frac{1}{1 + ct} \} \times exp ( - dt ) ] \text{/} [ 2 + b ] \qquad [ Equation 3 ]$$

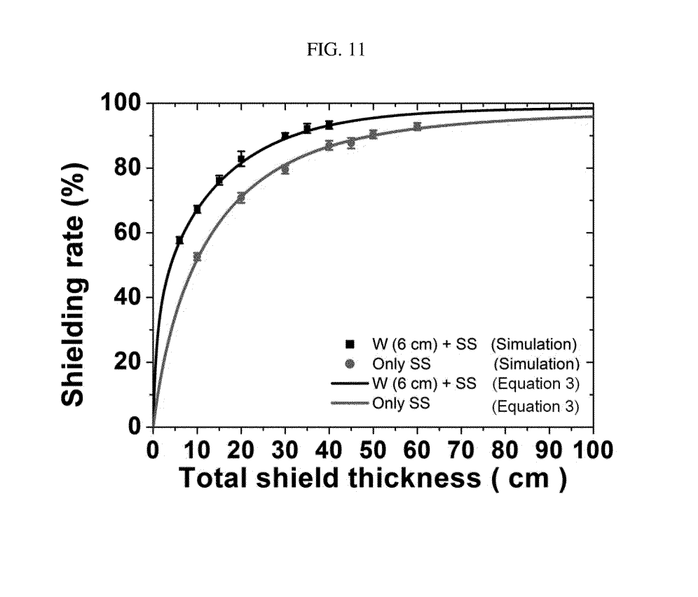

FIG. 11 illustrates another exemplary embodiment. In Equation 3, when the first shielding member 200 is made of tungsten (W) (t=6 cm) and the second shielding member 300a is made of the stainless steel (SS), the parameters of Equation 3 are a=0.06, b=0.03, c=1, and d=0.003.

When both of the first and second shielding members 200 and 300a are made of stainless steel (SS), the parameters of Equation 3 are such that a=0.06, b=0.13, c=0.158, and d=0.008.

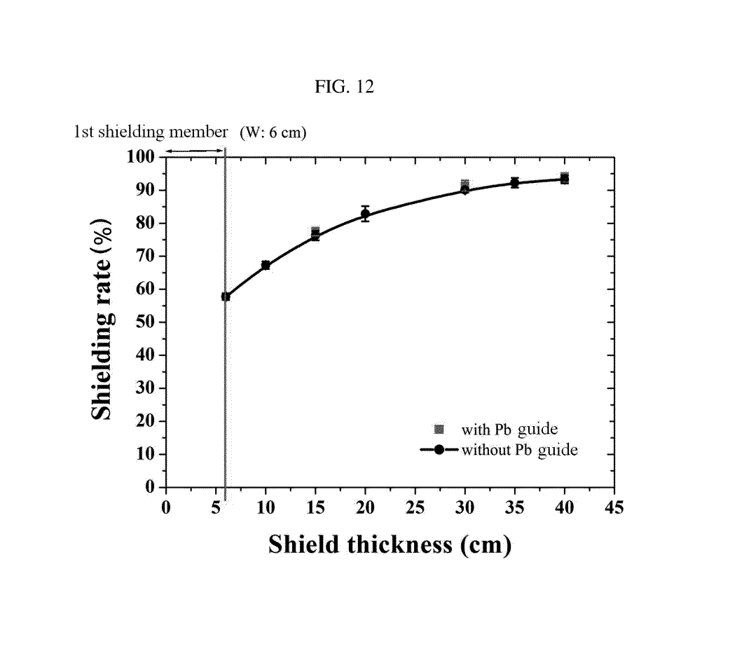

FIG. 12 is a graph showing the shielding rate of the situation for an uncollimated source 10b as shown in FIG. 10. FIG. 12 shows the comparison of the shielding rates between the two cases when the tapered lead guide 400 is inserted of not. It shows the shielding effect of the lead guide 400 is very minor.

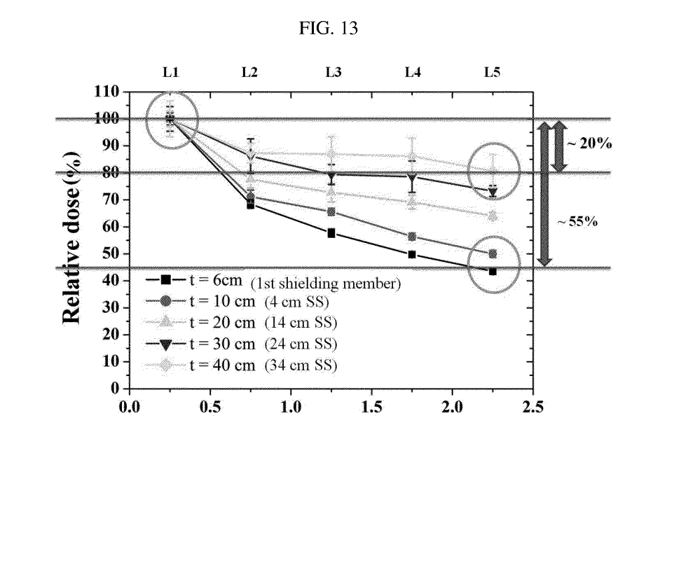

FIG. 13 is a graph showing the relative dose against the depth in the water phantom 100 for different values of the thickness of the shielding members when an uncollimated source 10b is used without the radiation guide part installed.

FIG. 13 shows the relative dose as a function of the depth in the water phantom 100, wherein, when only the first shielding member 200 of 6 cm thickness t is used, or when both the first and second shielding members 200 and 300a are used with the total thickness t thereof being 10 cm, 20 cm, 30 cm, and 40 cm.

As shown in FIG. 13, when the total thickness t of the shielding members is 40 cm, the difference between the relative doses at the depth of 0.25 cm (for the voxel L1 in FIG. 4) in the water phantom 100 and at the depth of 2.25 cm (for the voxel L5 in FIG. 4) therein is 20%, but when the thickness t is 6 cm, the difference in the relative doses between the same voxels is about 55%.

Therefore, it can be seen that as the thickness t of the shielding member becomes greater, the deposited dose becomes more uniform in depth, which is often desired for medical or research purposes.

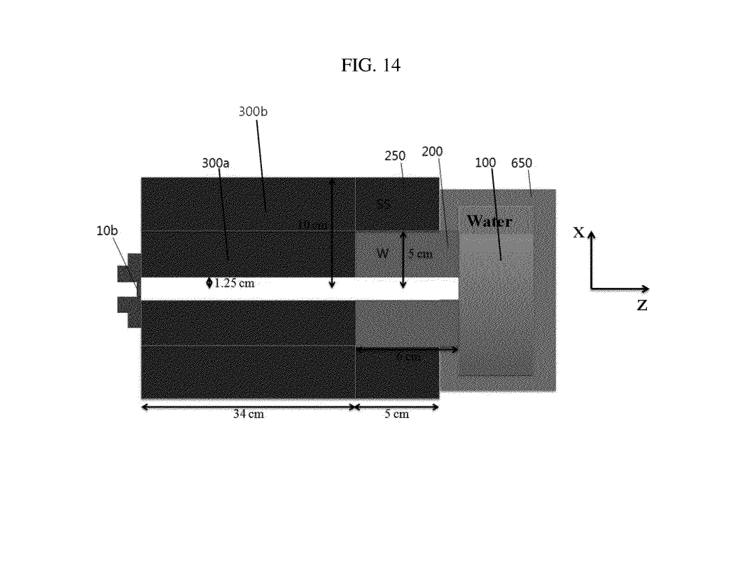

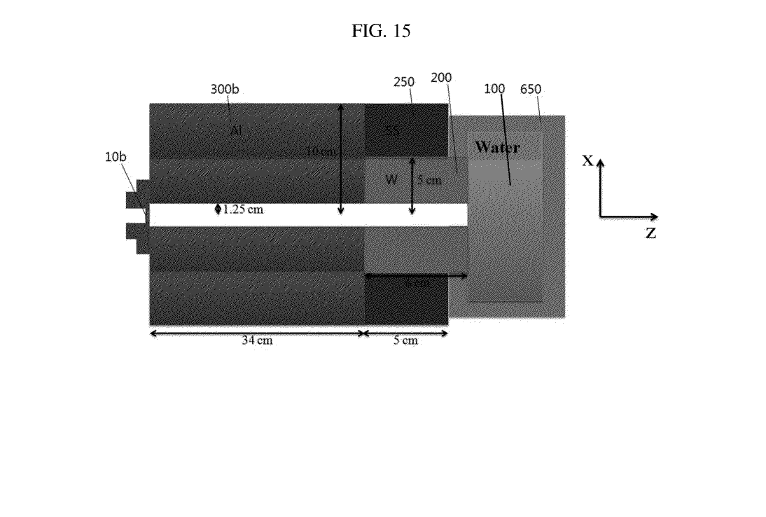

FIG. 14 is a schematic side view illustrating the case in which an external shield member 300b made of stainless steel is added to the situation shown in FIG. 8 when an uncollimated source 10b is used and the second shielding member 300a is made of stainless steel (SS). FIG. 15 is a schematic side view illustrating the case in which the second shielding member is made of aluminum (Al), when an uncollimated source 10b is used.

In the exemplary embodiment of the present invention, to model an optimal radiation shield for a small animal when an uncollimated source 10b is used, the second shielding member can be made of stainless steel (SS) as illustrated in FIG. 14, or aluminum (Al) as illustrated in FIG. 15.

The external diameter of the external second shielding member 300b is 10 cm, and the through-hole 210 of the second shielding member 300a has a diameter of 1.25 cm.

The first external shielding member 250 in FIG. 14 made of stainless steel (SS) is provided outside the first shielding member 200, and the external diameter of the stainless steel (SS) body is 10 cm.

The external shielding members 250 and 300b is installed to prevent any radiation from entering the water phantom 100 and causing an influence on the water phantom, in particular, if the radiation source is very broad as can be provided by a large experimental facility. This is especially to protect the area of the water phantom protruding lengthwise and thus unprotected by the limited dimension of the first shielding member made of tungsten, because the diameter of tungsten was chosen to be 5 cm to minimize the cost and weight while sufficient shielding is achieved.

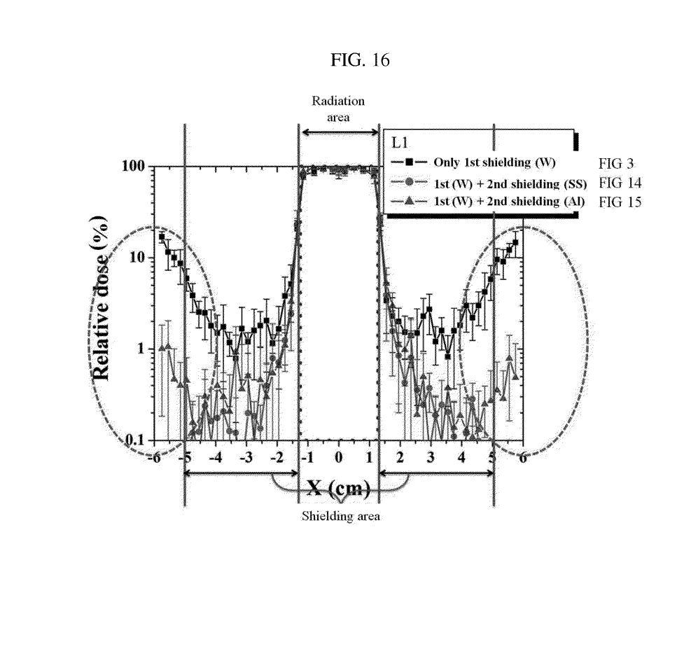

FIG. 16 is a graph showing the distribution of the relative dose deposited to the water phantom 100 as a function of the transverse distance X as shown in FIGS. 3, 14, and 15.

As illustrated in FIG. 16, the relative dose of about 100% is deposited to the target area of diameter of 1.25 cm, and the deposited dose is sharply reduced with increasing distance X from the center. When only the first shielding member 200 is used, a relative dose of about 10% is deposited at a position 5 cm apart or farther from the center. When all of the shielding members 200, 300a and 300b are used, a relative dose of only about 1% or less is deposited at the position 5 cm apart from the center, regardless of whether the material is stainless steel (SS) or aluminum (Al).

As described above, in the exemplary embodiment of the present invention, when a collimated source 10a is used, it is possible to obtain a high shielding effect of 90% or higher by using only the first shielding member 200 made of 6 cm thick tungsten.

When the second shielding members 300a and 300b with a thickness of 34 cm is added, the shielding effect is further improved than when only the first shielding member 200 is provided.

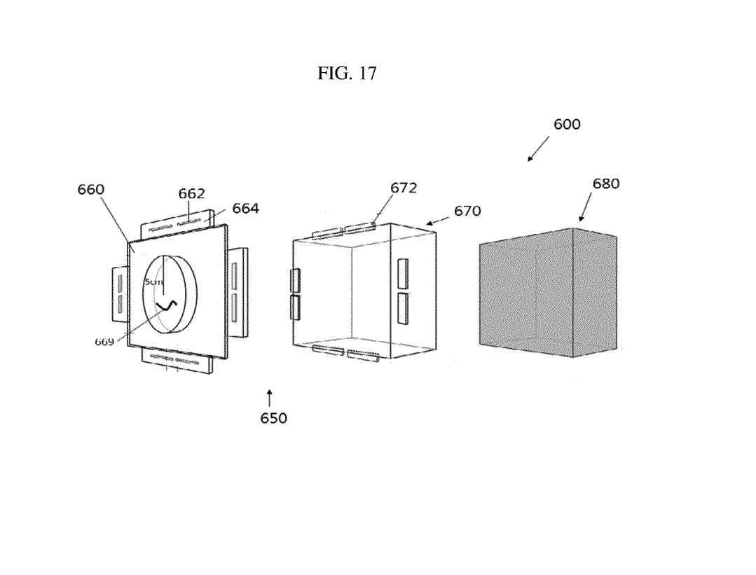

FIG. 17 is a schematic side view of a fixing part 600 used in the radiation shield.

A fixing frame 650 in FIGS. 13, 15 and 17 which surrounds the water phantom 100 has a thickness of 1 cm with a hole having the same diameter as the outer diameter of the first shielding member 200. The first shielding member 200 is directly in contact with the water phantom 100.

The fixing part 600 may include the fixing frame 650 having a shielding hole 669 which has a diameter of 5 cm and a memory member 680 made of a rectangular parallelepiped polyurethane material to be placed in an inner space of the fixing frame 650.

The fixing frame 650 containing a plastic material includes a cover 660 having the shielding hole 669 and a body 670 coupled with the cover 660.

The cover 660 has a quadrilateral shape, and a protruding portion 664 having a coupling groove 662 is bendably formed at each side surface of the cover 660.

The body 670 has a coupling protrusion 672 formed at each side surface thereof to be coupled to the coupling groove 662.

Therefore, the cover 660 is in close contact with the body 670, and then the coupling protruding portion 664 can be bent so that the coupling groove 662 is coupled with the coupling protrusion 672, and thus the cover 660 is coupled to the body 670.

The memory member 680 may be manufactured to have various volumes, may be formed to have the same size as the inner space of the fixing frame 650, and may be freely deformed according to a shape of the object to be inspected or treated, and thus the object may be fixed in various postures.

A small animal can be fixed to the memory member 680 in the fixing frame 650 so that a part of the body of a small animal, to which the radiation is to be irradiated, may be located on the same line as the center of the shielding hole 669. Then, the fixing frame 650 is in close contact with the rear surface of the first shielding member 200.

The fixing frame 650 contains the plastic material which has hardly an influence on penetration of the radiation.

The fixing frame 650 has advantages of being easily manufactured and light weighted.

According to the present invention, a part of the object to be inspected or treated, to which the irradiation is not needed, may be maximally shielded, and only a part thereof, to which the irradiation is needed, may be locally irradiated with the radiation.

According to the present invention, since the radiation is irradiated only to a target area, it is possible to provide the radiation shield which may locally irradiate the radiation to an object to be inspected or treated.

It is possible to provide the radiation shield which may be used along with the irradiation apparatus (⁶⁰Co Therapy or CyberKnife for the collimated source) universally used in the existing medical institutions and also may enable separate radioactive sources (the uncollimated source) to be used.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

1. A radiation shield to locally irradiate radiation, comprising:
a source irradiating the radiation; and
a shielding member formed so that the radiation is applied only to an object or a body to be inspected or treated and the other parts are shielded.

2. The radiation shield of claim 1, wherein the shielding member has a through-hole through which the radiation passes.

3. The radiation shield of claim 2, wherein the source is a collimated source (10a) or an uncollimated source (10b), and the shielding member is decided by a relative absorbed dose, and the relative absorbed dose is calculated by Equation 1, as follows:
$$100 \times \frac{{[ exp ( - μ ρ t ) ]}^{a}}{1 + {bt}^{2} + ct} \times [ \frac{1}{1 + {dt}^{3} + {et}^{2} + f t} ] \qquad [ Equation 1 ]$$
wherein μ is the attenuation coefficient [cm²/g], ρ is the density [g/cm³] of the shielding member, t is the thickness [cm] of the shielding member, and Z is atomic number of the shielding member, (a=a₁×ρ^{a}^{₂}×Z^{a}^{₃}, b=b₁×ρ^{b}^{₂}×Z^{b}^{₃}, c=c₁×ρ^{c}^{₂}×Z^{c}^{₃}), where the parameters are described in the embodiment.

4. The radiation shield of claim 3, wherein the shielding member can be formed of one or more of tungsten (W), lead (Pb), copper (Cu), stainless steel (SS), and aluminum (Al) according to the relative absorbed dose of Equation 1, Any other materials can also be used for the shielding member by using Equation 1.

5. The radiation shield of claim 4, wherein, when a collimated source (10a) is used, the shielding member is decided by the shielding rate, and the shielding rate of the shielding member is decided by Equation 2A for ⁶⁰Co therapy or Equation 2B for CyberKnife as follows:
$$\begin{matrix}100 - 100 [ {\{ exp ( - μ ρ t ) \}}^{a} + \{ b + \frac{c}{d} \} \times \{ {exp ( - μ ρ t \}}^{e} ] / [ 1 + b + c ] \\ ( a = {a}_{1} \times {ρ}^{{a}_{2}} , b = 1 / ( {b}_{1} \times {ρ}^{{b}_{2}} ) , d = 1 + {d}_{1} {ρ}^{{d}_{2}} {Z}^{{d}_{s}} t ) . & [ Equation 2 A ] \\ 100 - 100 [ {\{ exp ( - μ ρ t ) \}}^{a} + \{ b + c \times \frac{d}{e} \} \times \{ {exp ( - μ ρ t \}}^{f} ] / [ 1 + b + c ] \\ ( a = {a}_{1} \times {ρ}^{{a}_{2}} , b = {b}_{1} + {b}_{2} \times {Z}^{{b}_{2}} , c = {c}_{1} \times {ρ}^{{c}_{1}} \times {Z}^{{c}_{3}} , d = {\{ exp ( - \frac{1}{{d}_{1} {ρ}^{{d}_{2}}} t ) \}}^{{d}_{3} {ρ}^{d}} , e = 1 , {e}_{1} t ) , & [ Equation 2 B ]\end{matrix}$$
and
the shielding member consists of only the first shielding member 200 decided by Equation 2A or 2B.

6. The radiation shield of claim 4, wherein, when an uncollimated source (10b) is used, the first shielding member (200) of the shielding members is made of one of tungsten or stainless steel as described by Equations 1, 2A and 2B, and
further comprising the second shielding member made of stainless steel or aluminum as described by Equation 3 by taking into account the first shielding member simultaneously.

7. The radiation shield of claim 6, wherein the shielding rate of the first shielding member (200) and the second shielding member (300a) is decided by Equation 3 as follows:
$$100 - 100 [ exp ( - at ) + \{ b + \frac{1}{1 + ct} \} \times exp ( - dt ) ] \text{/} [ 2 + b ] \qquad [ Equation 3 ]$$
where the parameters a, b, c, and d are described in the embodiment.

8. The radiation shield of claim 5, wherein the thickness (t) of the first shielding member (200) is decided by Equation 2A or 2B.

9. The radiation shield of claim 6, wherein the thickness (t) of the second shielding member (300a or 300b) is decided by Equation 3.

10. The radiation shield of claim 5, further comprising:
a fixing frame (650) having a hole (669) in which the first shielding member (200) is to fit; and
a memory member (680) to be placed in an internal space of the fixing frame (650).

11. The radiation shield of claim 10, wherein the memory member (680) comprises a polyurethane material which can be freely deformed according to the shape of an object or body to be inspected or treated.
